(19) United States
(12) Patent Application Publication
(10) Pub. No.: US 2013/0163762 A1
(43) Pub. Date: Jun. 27, 2013

(54) RELAY NODE DEVICE AUTHENTICATION MECHANISM

(71) Applicants: Xiaowei Zhang, Tokyo (JP); Anand Raghawa Prasad, Tokyo (JP)

(72) Inventors: Xiaowei Zhang, Tokyo (JP); Anand Raghawa Prasad, Tokyo (JP)

(73) Assignee: NEC CORPORATION, Tokyo (JP)

(21) Appl. No.: 13/814,690

(22) PCT Filed: Jun. 4, 2011
(86) PCT No.: PCT/JP2011/065234

§ 371 Date: Feb. 6, 2013

(30) Foreign Application Priority Data
Sep. 13, 2010 (JP) 2010-204863

(51) Int. Cl. H04W 12/04

(52) U.S. Cl. CPC H04W 12/04
USPC 380/270

(57) ABSTRACT

A solution of relay node authentication is proposed. The solution includes mutual authentication of relay node and relay UICC, mutual authentication of relay node and network, secure channel establishment between relay UICC and relay node. AKA procedure in TS 33.401 is re-used so that no extra NAS message is needed. IMEI is sent to network in the initial NAS message, according to which MME-RN can retrieve RN's public key from HSS, and perform access control for DeNB. MME-RN will generate a session key based on IMSI, IMEI and Kasme, and encrypt it by RN's public key and send it to RN. UICC will also generate the same key and thus RN can authenticate both UICC and network. When the key or other parameters sent between UICC and RN do not match, UICC or RN will send Authentication Reject message with a new cause to inform network.

### TECHNICAL FIELD

A mechanism is proposed for mutual authentication between Relay Node (RN) device and network, mutual authentication and secure channel establishment between relay-Universal Integrated Circuit Card (UICC) and relay device. It provides a solution re-using Authentication and Key Agreement (AKA) procedure and initial Non-Access Strum (NAS) procedure in Non Patent Literature (NPL) 3, in order to prevent attacks (NPL 2). It prevents malicious modification or misuse of relay-UICC, relay device configuration, interception and modification of the messages between them.

### BACKGROUND ART

The Third Generation Partnership Project's (3GPP's) Long Term Evolution (LTE)-Advanced is considering relaying for cost-effective throughput enhancement and coverage extension (see NPL 1). In the relay architecture, man-in-the-middle (MitM) attack, communication hijack and several other attacks are possible if the communication between relay-UICC (UICC will be used for relay-UICC onwards in this invention) and network and/or between RN and network is not secure. Moreover, during authentication for UICC, the authentication parameters are transferred through RN and the connection between UICC and RN platform. An intruder could capture, modify or inject the message and authentication data.

Since RN device has a removable UICC (see NPL 2). It is possible that a UICC is inserted into another RN which is not authorized by the operator. Moreover communication between UICC and RN must be secure authenticated and confidentiality protected. However, the AKA procedure of SAE (System Architecture Evolution)/LTE disclosed in NPL 3 is not suitable for relay node case, because it does not provide a solution for the platform authentication.

Therefore, it is sufficient that mutual authentication is not only provided for UICC and network, but also for RN and network, and UICC and RN platform.

### CITATION LIST

Non Patent Literature

NPL 1: TR 36.806, “Relay architectures for E-UTRA (LTE-Advanced) (Release 9)”, V9.0.0, 2010-03

NPL 2: S3-100896, “Living Document on “Key Security Issues of Relay Node Architectures””

NPL 3: TS 33.401, “3GPP System Architecture Evolution (SAE); Security architecture (Release 9)”, V9.4.0, 2010-06

### SUMMARY OF INVENTION

In this document we propose a solution for relay node authentication that provides (1) mutual authentication for both UICC and relay node device with the network, (2) secure binding of UICC and relay node device, and (3) secure channel creation between UICC and relay node device. The proposed solution mitigates threats 1 to 5 mentioned in NPL 2. This solution also fulfils other requirements of relay node like the reuse of AKA procedure, relay node connecting only to a DeNB (Doner evolved Node B) and prevention of multi-hop creation by relay nodes. The solution is also future proof because it can be used without modification for mobility (current relay node specification is focused on fixed deployment for coverage extension).

### Authentication

We require UICC to network mutual authentication, relay device to network mutual authentication and binding between UICC and relay device; all this is achieved as follows:

1. UICC and network mutual authentication is achieved by EPS (Evolved Packet System) AKA.

2. Relay device is authenticated by the network based on message encrypted by relay device using the private key.

3. In the proposed solution keys Kri and Krc are generated for secure communication between UICC and relay device. Kri and Krc can only be created by the network and the USIM (Universal Subscriber Identity Module). Kri and Krc are sent encrypted to the relay device using the public key of the relay device. Thus only the relay device can decrypt the message and verify the MAC (Message Authentication Code) with Kri from the USIM. Thus the relay device authenticates network because the network is holding the same root key as the USIM.

4. The relay device sends a Krc encrypted value (say IMSI (International Mobile Subscriber Identity)) to the network in Authentication Response thus proving that it holds the private key of the message sent with RN keys and that it is with the UICC because it has the RES (authentication response) from the USIM. Thus there is a proof of binding between the UICC and the RN.

### Threat Mitigation

Threat 1: Mitigated by authentication of relay device, UICC and binding between them.

Threat 2: Message authentication codes mitigate this threat during authentication. After authentication the man-in-the-middle will need the keys used for integrity and/or confidentiality protecting the traffic between the relay device and the network.

Threat 3: Mitigated by EPS security procedure of using UP (User Plane) confidentiality and for integrity the proposed solution is dependent on IPsec (security architecture for Internet Protocol) or creation of new key for integrity protection of UP.

Threat 4: Taken care of by authentication discussed.

Threat 5: Creation of key Kri and Krc at USIM and usage of the same at the relay device leads to secure communication between USIM and relay device from the vey beginning, i.e., even before CK (Cipher Key), IK (Integrity Key) is transferred.

### Other Requirements

AKA procedure is maintained.

Man-in-the-middle and also multi-hop is not possible, even if such action is taken it will only lead to “relaying” of traffic without attack on the communication from the relay node.

Attach Accept, protected by algorithm selected during NAS SMC (Security Mode Command), from the MME (Mobility Management Entity) contains the DeNB list the relay node is allowed to communicate with leading to the relay connecting to the correct DeNB.

### ADVANTAGEOUS EFFECTS OF INVENTION

Relay node platform and network are able to obtain mutual authentication. Relay node platform and UICC also are able to obtain mutual authentication. The mutual authentication ensures that an UE (User Equipment)-UICC or any other fraud UICC will not be misused in a RN and also prevents to misuse relay device which does not belong to the operator.

AKA procedure sequence disclosed in NPL 3 for UE and MME is re-used so that signaling is not increased and the key hierarchy remains the same.

Secure channel is established between UICC and RN platform such that CK, IK are sent encrypted.

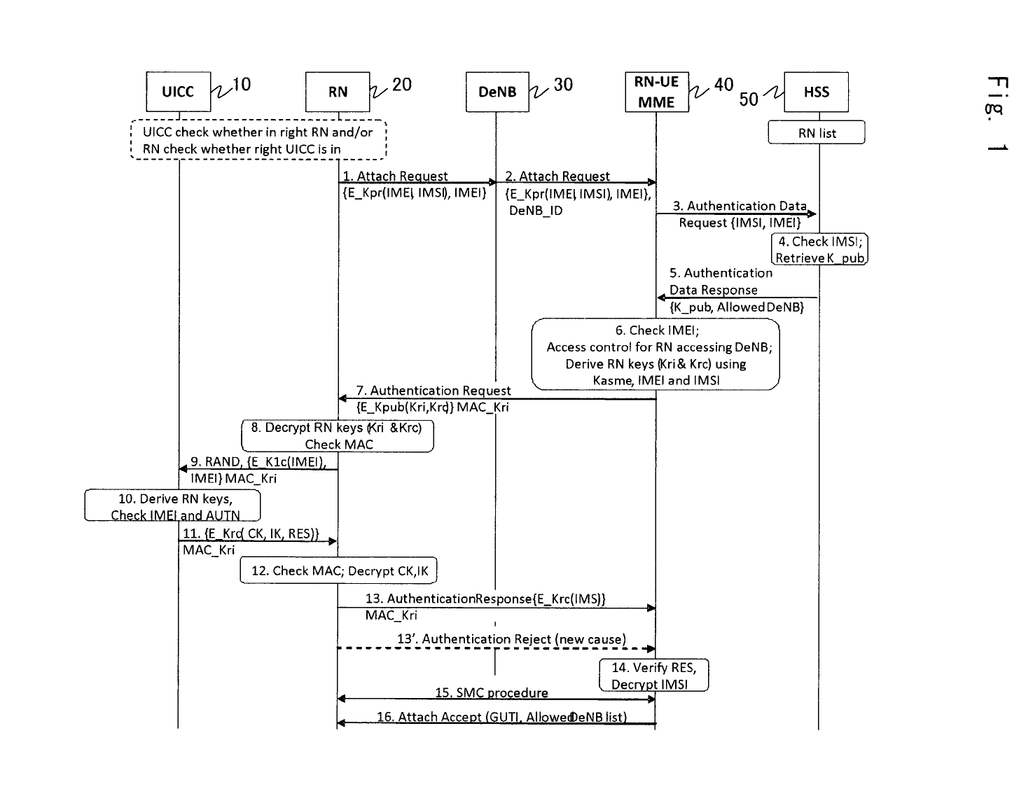

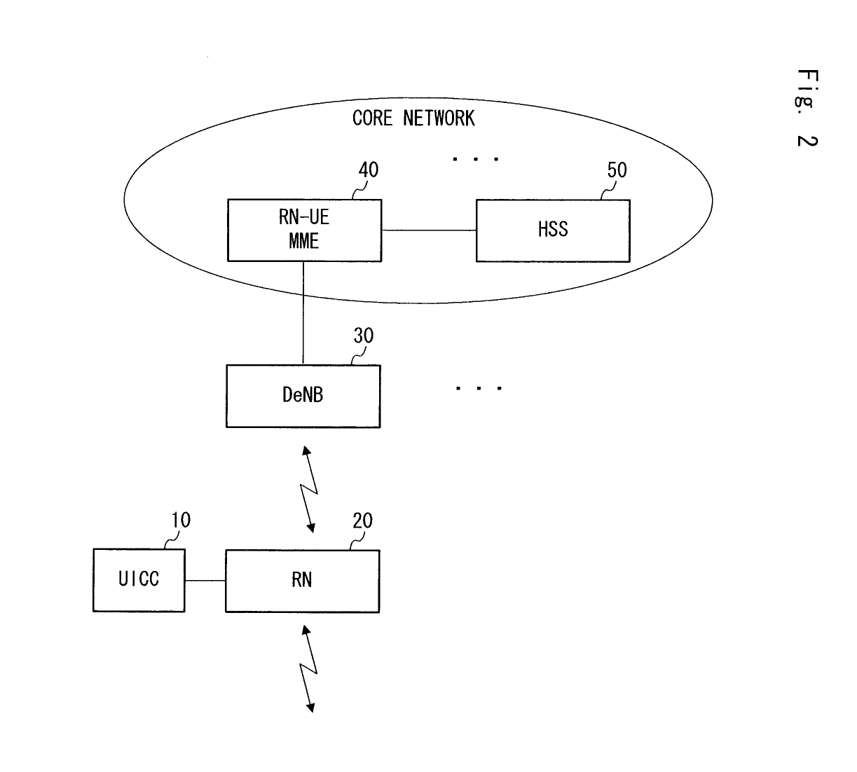

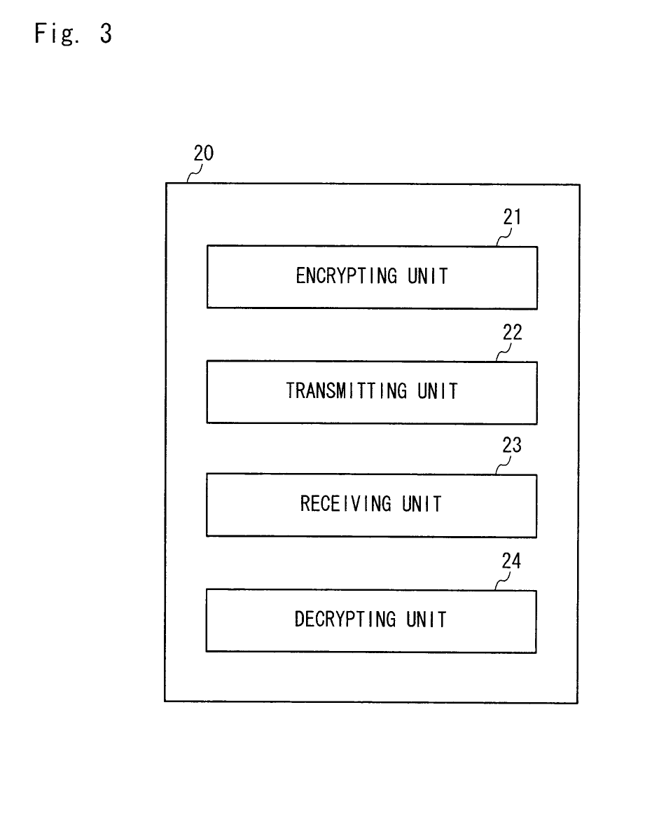

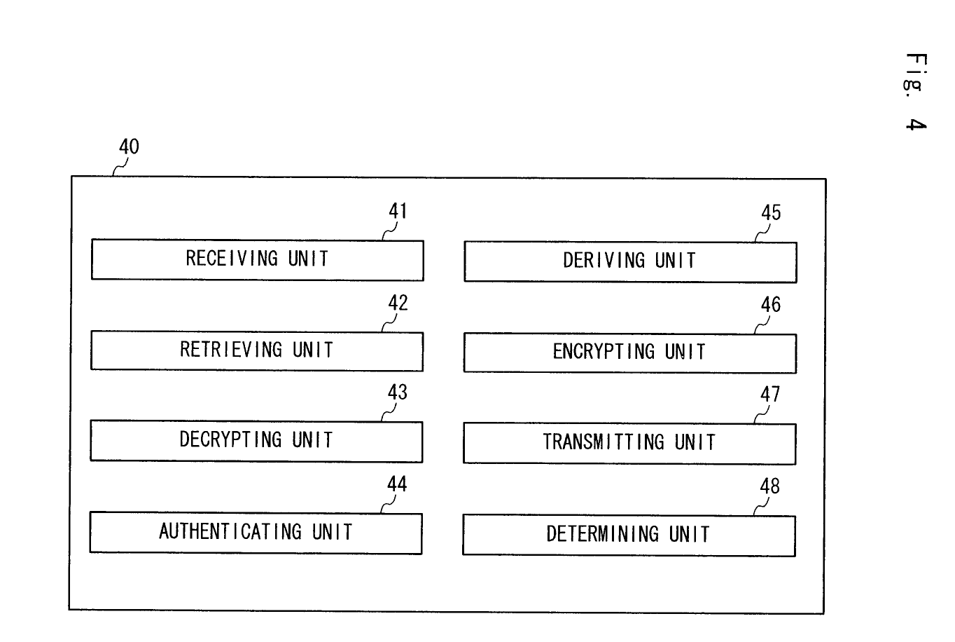

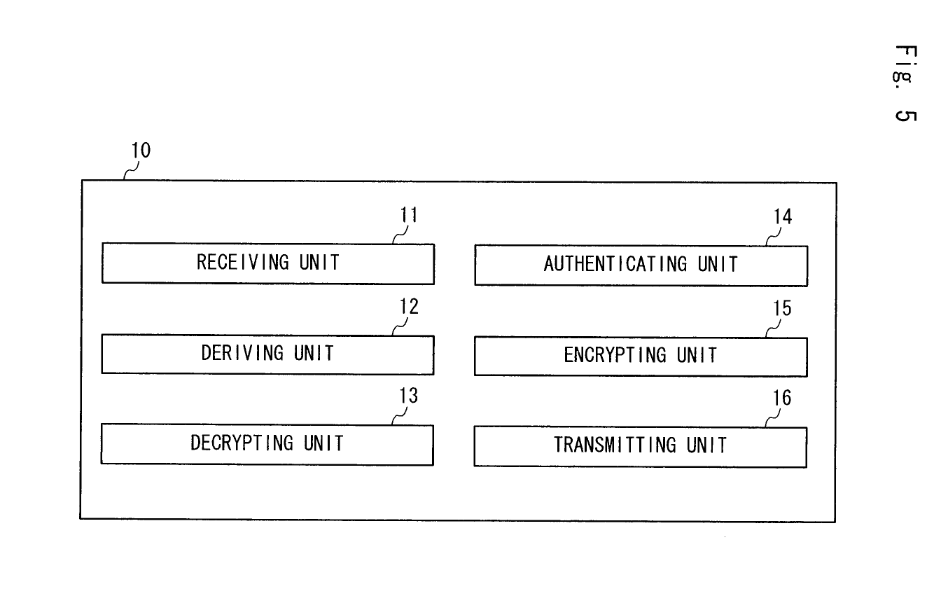

### BRIEF DESCRIPTION OF DRAWINGS

[FIG. 1] FIG. 1 is a sequence diagram showing an example of Proposed solution.

[FIG. 2] FIG. 2 is a block diagram showing a configuration example of a network system according to an exemplary embodiment of the present invention.

[FIG. 3] FIG. 3 is a block diagram showing a configuration example of a relay node according to an exemplary embodiment of the present invention.

[FIG. 4] FIG. 4 is a block diagram showing a configuration example of a network node according to an exemplary embodiment of the present invention.

[FIG. 5] FIG. 5 is a block diagram showing a configuration example of an ICC according to an exemplary embodiment of the present invention.

### DESCRIPTION OF EMBODIMENTS

Hereafter, an exemplary embodiment of a relay node, a network node and an ICC according to the present invention, and a network system to which these nodes and ICC are applied will be described with reference to FIGS. 1 to 5. Note that the same signs are assigned to the same elements throughout the drawings, and their duplicated explanation is omitted as appropriate for clarifying the description.

As shown in FIG. 2, the network system according to this exemplary embodiment includes a UICC10, an RN 20, a DeNB 30, an MME 40, and an HSS 50. The UICC 10 is bound to the RN 20. The RN 20 wirelessly relays traffic between a UE (not shown) and the DeNB 30. The MME 40 performs access control for the DeNB 30, by communicating with the HSS 50 if necessary. Note that configuration examples of the UICC 10, the RN 20 and the MME 40 will be described later with reference to FIGS. 3 to 5.

In this exemplary embodiment, we propose a solution for relay node authentication that provides (1) mutual authentication for both UICC and relay node device with the network, (2) secure binding of UICC and relay node device, and (3) secure channel creation between UICC and relay node device. The proposed solution mitigates threats 1 to 5 mentioned in the relay node security living document. This solution also fulfils other requirements of relay node like the reuse of AKA procedure, relay node connecting only to a DeNB and prevention of multi-hop creation by relay nodes. The solution is also future proof because it can be used without modification for mobile relay nodes (relay node being currently standardized is considered to be static and for coverage extension purpose).

The AKA procedure in NPL 3 is re-used with modification for RN authentication. The solution assumes that:

1. UICC is removable.

2. The communication between DeNB and network is secure.

3. The RN has a digital certificate.

For the discussion following sections Kpub is the public key of RN, which is mapped to the identity of the RN that is assumed to be IMEI (International Mobile Equipment Identity); Kpr is the private key of RN.

Keys generated for secure communication between the relay device and UICC are Kri, for integrity protection, and Krc, for confidentiality protection; this key pair is named as RN keys. RN keys are generated using Kasme (Key Access Security Management Entity), IMEI, and IMSI assigned to UICC. Note that Kasme is a parameter which can be generated by only UICC and network (MME in this exemplary embodiment). Use of Kasme will enable UICC to authenticate MME, and to ensure secure communication between UICC and RN. Further, use of IMEI will enable RN to find out malicious modification thereof. This is because if IMEI is maliciously modified, CK and IK described later will not be properly decrypted by RN, so that the mismatch will be found out.

IMEI is sent to both of UICC and network for authentication purpose.

Allowed list of DeNBs to which the RN can access are sent to the RN on successful attach.

Optional features in the proposed solution:

1. In this solution it is optional that the UICC and RN locked to each other. This is not necessary part of the solution but we put this point as a note that the operator has a option to do so.

2. It is also optional for the HSS (Home Subscriber Server) to have a list of RN ID (IMEI in this proposal) and associated USIM. The solution works without any such pre-configuration.

### Relay Authentication Procedure

The proposed authentication procedure is depicted in FIG. 1. Those in dotted line are optional or optional at the given location; explanation is given in the following.

### Initialization

As initialization for the proposed solution the HSS 50 should know given IMEI (or any given identity) is that of a relay node so that it will retrieve the public key of the RN 20 when necessary.

Optionally, the USIM mounted on the UICC 10 and RN 20 can be locked to each other, i.e., the USIM will be pre-configured to only work with the given RN and the RN 20 will be pre-configured to only work with the given USIM. Thus when the USIM is placed in the RN 20, both USIM and RN 20 will perform a check whether they are in the right place. The solution works without this optional feature.

### Message Sequence

The message sequence of the proposed solution given in FIG. 1 is explained below:

1. RN 20 sends Attach Request message, including IMEI (or any other identity used for RN) that is encrypted by Kpr and also in plain text.

Optionally, Kpr encrypted IMSI can also be sent. This will allow HSS 50 to perform initial check regarding the binding of UICC 10 with RN 20.

2. DeNB 30 (this can also be a eNB) forwards the Attach Request message from RN 20 to MME-RN 40 and optionally adds its own identity (DeNB_ID) to the message. Sending of the eNB/DeNB identity will help the network verify whether the RN is allowed to attach to the given DeNB. This allows the network to take action if the given RN remains attached to the eNB/DeNB after attach complete even after it is not authorized to do so.

3. MME-RN 40 sends IMSI and IMEI to HSS 50 in Authentication Data Request message.

4. HSS 50 retrieves Kpub based on the received IMEI (or any other identity used for RN) and also the Allowed DeNB list for the RN 20.

Here, optionally, HSS 50 can determine whether the UICC 10 is relay type or bound to the given RN based on the received IMSI.

5. HSS 50 sends the retrieved data at Step 4 to MME-RN 40 in Authentication Data Response message.

6. MME-RN 40 decrypts IMEI with the received Kpub and compares it with unencrypted IMEI thus also authenticating the RN 20. Only RN 20 can have the Kpr and decrypted IMEI same as plain-text IMEI means no modification of message. MME-RN 40 performs access control of the RN 20 to the DeNB 30 based on received RN list, and derives a pair of RN keys (Kri, Krc) using IMSI, IMEI and Kasme.

7. MME-RN 40 sends the Authentication Request message including RN keys encrypted by Kpub and optionally IMEI encrypted by Krc. Optionally one can also send RAND encrypted by Kpub. The message is integrity protected by Kri.

8. RN 20 decrypts RN keys (and optionally RAND (random number)) with Kpr and verifies the MAC. Upon this verification, RN 20 generates a MAC by using the received message and Kri in accordance with a predetermined MAC algorithm, and then checks whether or not the generated MAC coincides with the received one.

9. RN 20 sends the RAND and IMEI to UICC. IMEI (or optionally the whole message itself) is sent both encrypted by Krc and in plain text; both are also integrity protected by Kri.

10. UICC 10 performs the usual AKA procedure with the received RAND (see NPL 3). Further the UICC 10 derives the RN keys (Kri and Krc) in the same way as the MME-RN 40 and verifies the encrypted IMEI using Krc and integrity of the message using Kri. This step proves to the UICC that the RN (i) is authenticated by the network and (ii) IMEI received belongs to the given RN.

11. UICC 10 sends encrypted and integrity protected CK, IK and RES to RN 20.

12. RN 20 checks MAC of the message received from UICC 10 and decrypts CK, IK and RES with Krc. This proves that the UICC and RN have the same key therefore (i) the network to which the RN is connected to is authentic and (ii) the UICC is authentic. The result is that a secure channel is created between the RN and the UICC.

13. RN 20 sends Authentication Response to MME-RN 40 including RES and IMSI encrypted by Krc. The encryption of RES is optional. The message is integrity protected by Kri.

13′. Optionally, Authentication Reject with a new cause can be sent to MME-RN 40, if RN keys do not match between the UICC 10 and the RN 20.

14. The MME-RN 40 verifies RES as standard AKA procedure (see NPL 3). MME-RN 40 also decrypts the IMSI. This step proves that (i) (Once again) Authenticates the RN, i.e., communicating RN is the one with the private key of the Kpub encrypted message in step 8, (ii) validation of RES proves that authentic UICC is with the RN and (iii) the given RN and UICC are together.

15. SMC procedure as given in NPL 3 is performed.

16. In the Attach Accept message, the Allowed DeNB list is sent to the RN 20. For example, the Allowed DeNB list stores one or more IMEIs in association with one or more IDs of eNBs. In this case, the RN 20 can attach to the eNB whose ID is associated with its own IMEI.

Next, configuration examples of the UICC 10, the RN 20 and the MME 40 will be described with reference to FIGS. 3 to 5.

As shown in FIG. 3, the RN 20 includes an encrypting unit 21, a transmitting unit 22, a receiving unit 23, and a decrypting unit 24.

The encrypting unit 21 encrypts each of the IMEI and IMSI with the Kpr. Further, the encrypting unit 21 encrypts the IMEI with the Krc. Furthermore, the encrypting unit 21 encrypts the IMSI with the Krc.

The transmitting unit 22 transmits each of the encrypted IMEI and IMSI together with it in plain text to the MME 40 through the DeNB 30. Further, the transmitting 22 transmits the encrypted IMEI together with it in plain text to the UICC 10. Furthermore, the transmitting unit 22 transmits the Authentication Reject message to the MME 40 through the DeNB 30.

The receiving unit 23 receives the encrypted Krc and Kri from the MME 40 through the DeNB 30. Further, the receiving unit 23 receives the encrypted CK and IK from the UICC 10.

The decrypting unit 24 decrypts the encrypted Krc and Kri with the Kpr. Further, the decrypting unit 24 decrypts the encrypted CK and IK with the decrypted Krc.

These units 21 to 24 can be configured by, for example, a repeater which wirelessly relays traffic between the UE and the DeNB 30, an interface which communicates with the UICC 10, and a controller which controls these repeater and interface, and performs the encryption and decryption to execute the processes shown in FIG. 1 or processes equivalent thereto.

As shown in FIG. 4, the MME 40 includes a receiving unit 41, a retrieving unit 42, a decrypting unit 43, an authenticating unit 44, a deriving unit 45, an encrypting unit 46, a transmitting unit 47, and a determining unit 48.

The receiving unit 41 receives each of the encrypted IMEI and IMSI together with it in plain text from the RN 20 through the DeNB 30. Further, the receiving unit 41 receives the Authentication Reject message from the RN 20 through the DeNB 30.

The retrieving unit 42 retrieves the Kpub from the HSS 50. Further, the retrieving unit 42 retrieves the Allowed DeNB list from the HSS 50.

The decrypting unit 43 decrypts the encrypted IMEI with the Kpub. Further, the decrypting unit 43 decrypts the encrypted IMSI with the Kpub or the Krc.

The authenticating unit 44 authenticates the RN 20 by comparing the decrypted IMEI with it in plain text. Further, the authenticating unit 44 authenticates the UICC 10 by notifying the HSS 60 of the decrypted IMSI to check whether or not the UICC 10 is allowed to be bound to the RN 20.

The deriving unit 45 derives the Krc and Kri by using the IMSI, IMEI and Kasme.

The encrypting unit 46 encrypts the Krc and Kri with the Kpub.

The transmitting unit 47 transmits the encrypted Krc and Kri to the RN 20 through the DeNB 30. Further, the transmitting unit 47 transmits the Allowed DeNB list to the RN 20 through the DeNB 30.

The determining unit 48 determines whether or not the RN 20 is allowed to access the DeNB 30. For example, when the IMEI of the RN 20 is stored in the Allowed DeNB list in association with the ID of the DeNB 30, the determining unit 48 allows the RN 20 to access the DeNB 30.

These units 41 to 48 can be configured by, for example, transceivers which respectively conduct communication with the DeNB 30 and the HSS 50, and a controller which controls these transceivers, and performs the decryption, authentication, derivation, encryption, decryption and determination to execute the processes shown in FIG. 1 or processes equivalent thereto.

As shown in FIG. 5, the UICC 10 includes a receiving unit 11, a deriving unit 12, a decrypting unit 13, an authenticating unit 14, an encrypting unit 15, and a transmitting unit 16. The receiving unit 11 receives the encrypted IMEI and it in plain text from the RN 20. The deriving unit 12 derives the Krc and Kri by using the IMSI, IMEI and Kasme. Further, the deriving unit 12 derives the CK and IK. The decrypting unit 13 decrypts the encrypted IMEI with the Krc. The authenticating unit 14 authenticates the RN 20 by comparing the decrypted IMEI with it in plain text. The encrypting unit 15 encrypts the CK and IK with the Krc. The transmitting unit 16 transmits the encrypted CK and IK to the RN 20.

These units 11 to 16 can be configured by, for example, a USIM, an interface which communicates with the RN 20, and a controller which controls these USIM and interface, and performs the derivation, decryption, authentication and encryption to execute the processes shown in FIG. 1 or processes equivalent thereto.

Note that the present invention is not limited to the above-mentioned exemplary embodiment, and it is obvious that various modifications can be made by those of ordinary skill in the art based on the recitation of the claims.

This application is based upon and claims the benefit of priority from Japanese patent application No. 2010-204863, filed on Sep. 13, 2010, the disclosure of which is incorporated herein in its entirety by reference.

The whole or part of the exemplary embodiment disclosed above can be described as, but not limited to, the following supplementary notes.

(Supplementary Note 1)

UICC and RN (optionally) perform a pre-check before any communication to network.

Operator can have pre-configured information about UICC and RN and configure them into each other. The information can be a sort of unique identifier. When UICC is inserted in the RN, they can use the information to verify if e.g. they have the binding according to operator's configuration, or if they are trustable, etc.

(Supplementary Note 2)

IMEI is used for RN device authentication.

IMEI is sent to network in an initial NAS message. According to which HSS can retrieve RN's public key and UICC can perform verification base on it such that RN can be authenticated by network.

In the Authentication Request message from RN to UICC, the IMEI is sent plain and optionally with encryption by Kr. If it is sent both plain and encrypted, UICC can compare them and verify if they are the same, such that RN can be authenticated UICC.

(Supplementary Note 3)

IMEI is used for key generation.

UICC and MME-RN use the IMEI to generate a session key Kr.

If the IMEI is maliciously modified, the CK, IK will not be decrypted properly by RN and the mismatch will be found out.

(Supplementary Note 4)

MME-RN performs access control for RN accessing a DeNB.

Relay communicates with network through DeNB. MME-RN can determine if the RN is authorized to access the DeNB. MME-RN will receive a RN list according to the DeNB identity which it received from DeNB in the initial NAS message.

(Supplementary Note 5)

Public key and session key mechanism are used.

Relay public key is used to authenticate RN by network. Network and UICC generate a pair of session keys including confidential and integrity key separately. The session key is used to encrypt IMEI, to generate MAC and also to encrypt CK, IK so that they can not be intercepted.

(Supplementary Note 6)

Establishment of secure channel between UICC and RN.

CK, IK are sent in encrypted message such that only an authenticated RN can obtain them.

(Supplementary Note 7)

RN sends encrypted RAND to network.

The RAND in Authentication Response message from RN to network is encrypted by RN with Kr. The encrypted RAND ensures that the UICC is at the RN but no where else.

(Supplementary Note 8)

New cause for Authentication Reject.

RN verifies the MAC received from UICC. It should send Authentication Reject with new proper cause, if the verification fails.

(Supplementary Note 9)

MME-RN should receive an Allowed DeNB list from HSS and send it to the RN which has been authenticated by both of the UICC and network, such that the RN will have the knowledge of which DeNBs it is allowed to access.

### REFERENCE SIGNS LIST

10 UICC

11, 23, 41 RECEIVING UNIT

12, 45 DERIVING UNIT

13, 24, 43 DECRYPTING UNIT

14, 44 AUTHENTICATING UNIT

15, 21, 46 ENCRYPTING UNIT

16, 22, 47 TRANSMITTING UNIT

20 RN

30 DeNB

40 MME

42 RETRIEVING UNIT

48 DETERMINING UNIT

50 HSS

1. A relay node capable of wirelessly relaying traffic between a UE (User Equipment) and a base station, the relay node comprising:
a first unit that encrypts an identifier of the relay node with a private key for the relay node;
a second unit that transmits, through the base station to a network having a public key for the relay node, the encrypted identifier and the identifier in plain text;
a third unit that receives, from the network through the base station, a first session key encrypted with the public key, the first session key being derived by use of at least information on an ICC (Integrated Circuit Card) allowed to be bound to the relay node; and
a fourth unit that decrypts the first session key with the private key,
wherein the first unit encrypts the identifier with the decrypted first session key,
wherein the second unit transmits, to an ICC bound to the relay node, the identifier encrypted with the decrypted first session key and the identifier in plain text to make the bound ICC authenticate the relay node.

2. (canceled)

3. The relay node according to claim 1, wherein the information includes at least one of an identifier assigned to the allowed ICC, and a parameter that can be generated by the allowed ICC.

4. The relay node according to claim 1, wherein the first session key is derived by use of the identifier of the relay node in addition to the information.

5. The relay node according to claim 1,
wherein the third unit receives, from the bound ICC, an encrypted second session key for securely conducting communication between the relay node and the bound ICC,
wherein the fourth unit decrypts the second session key with the decrypted first session key.

6. The relay node according to claim 1,
wherein the first unit encrypts, when the bound ICC succeeds in the authentication of the relay node, an identifier of the bound ICC with the decrypted first session key,
wherein the second unit transmits, to the network through the base station, the encrypted identifier of the bound ICC.

7. The relay node according to claim 1, wherein the second unit transmits, when the bound ICC fails in the authentication of the relay node, a cause for the failure to the network through the base station.

8. The relay node according to claim 1,
wherein the first unit encrypts an identifier of an ICC bound to the relay node with the private key,
wherein the second unit transmits, to the network through the base station, the encrypted identifier of the ICC to make the network check whether or not the bound ICC is allowed to be bound to the relay node.

9. A network node that performs access control for a base station, the network node comprising:
a first unit that receives, through the base station from a relay node that can wirelessly relay traffic between a UE (User Equipment) and the base station, an identifier of the relay node encrypted with a private key for the relay node and the identifier in plain text;
a second unit that retrieves a public key for the relay node from a server;
a third unit that decrypts the encrypted identifier with the public key;
a fourth unit that authenticates the relay node by comparing the decrypted identifier with the identifier in plain text;
a fifth unit that derives a first session key by use of at least information on an ICC (Integrated Circuit Card) allowed to be bound to the relay node;
a sixth unit that encrypts the first session key with the public key; and
a seventh unit that transmits the encrypted first session key to the relay node through the base station.

10. (canceled)

11. The network node according to claim 9, wherein the fifth unit uses, as the information, at least one of an identifier assigned to the allowed ICC, and a parameter that can be generated by the allowed ICC.

12. The network node according to claim 9, wherein the fifth unit derives the first session key by use of the identifier of the relay node in addition to the information.

13. The network node according to claim 9,
wherein the first unit receives, from the relay node through the base station, an identifier of an ICC bound to the relay node, the identifier of the bound ICC being encrypted with the private key,
wherein the third unit decrypts the identifier of the bound ICC with the public key,
wherein the fourth unit authenticates the bound ICC based on the decrypted identifier of the ICC.

14. The network node according to claim 13, wherein the fourth unit authenticates the bound ICC, by notifying the server of the decrypted identifier of the ICC to check whether or not the bound ICC is allowed to be bound to the relay node.

15. The network node according to claim 9, further comprising:
a unit that determines whether or not the relay node is allowed to access the base station based on the identifier of the relay node.

16. The network node according to claim 9, wherein the first unit receives, when an ICC bound to the relay node fails in authentication of the relay node, a cause for the failure from the relay node through the base station.

17. The network node according to claim 9,
wherein the second unit retrieves, from the server, a list of one or more base stations which the relay node is allowed to access,
wherein the seventh unit transmits the list to the relay node through the base station.

18. An ICC (Integrated Circuit Card) capable of being bound to a relay node that wirelessly relays traffic between a UE (User Equipment) and a base station, the ICC comprising:
a first unit that receives, from the relay node, an encrypted identifier of the relay node and the identifier in plain text;
a second unit that derives a first session key by use of at least information on the ICC;
a third unit that decrypts the encrypted identifier with the first session key; and
a fourth unit that authenticates the relay node by comparing the decrypted identifier with the identifier in plain text.

19. The ICC according to claim 18, wherein the second unit uses, as the information, at least one of an identifier assigned to the ICC and a parameter that can be generated by the ICC.

20. The ICC according to claim 18, wherein the second unit derives the first session key by use of an identifier of a relay node to which the ICC is allowed to be bound, in addition to the information.

21. The ICC according to claim 18, further comprising:
a unit that derives a second session key for securely conducting communication between the relay node and the ICC;
a unit that encrypts the second session key with the first session key; and
a unit that transmits the encrypted second session key to the relay node.

22-40. (canceled)
